(19) United States
(12) Patent Application Publication
(10) Pub. No.: US 2011/0268304 A1
(43) Pub. Date: Nov. 3, 2011

(54) HEARING AID WITH EAR-HOOK SAFETY MECHANISM

(75) Inventors: KerSer Ang, Singapore (SG); Chong Neng Cho, Singapore (SG); Markus Heerlein, Kitzingen (DE); Harald Klemenz, Furth (DE); Peter Nikles, Erlangen (DE); Yi Ren Chris Tan, Singapore (SG)

(73) Assignee: SIEMENS MEDICAL INSTRUMENTS PTE. LTD., Singapore (SG)

(21) Appl. No.: 13/096,158

(22) Filed: Apr. 28, 2011

(30) Foreign Application Priority Data
Apr. 28, 2010 (DE) DE 102010018544.2

(51) Int. Cl. H04R 25/00

(52) U.S. Cl. 381/330

(57) ABSTRACT

Children should be prevented from easily being able to remove the ear hook of a hearing aid. It is for this reason that a hearing aid that is to be worn behind an ear has a housing, which houses signal-processing components, and an ear hook, which is detachably attached to the housing. During the attachment process, the ear hook is moved toward the housing in an axial direction. The ear hook and the housing are embodied such that, in order to attach the ear hook to the housing, there is at least one movement of the ear hook in a second direction and a movement of the ear hook in a third direction, which differs from the second direction. Both the second and the third direction differ from the first direction. It follows that a complicated movement pattern is required when the ear hook is disassembled from the housing.

### CROSS-REFERENCE TO RELATED APPLICATION

This application claims the priority, under 35 U.S.C. §119, of German application DE 10 2010 018 544.2, filed Apr. 28, 2010; the prior application is herewith incorporated by reference in its entirety.

### BACKGROUND OF THE INVENTION

### Field of the Invention

The present invention relates to a hearing aid to be worn behind an ear. The hearing aid contains a housing, which houses signal-processing components, and an ear hook, which is embodied for detachable attachment to the housing.

Hearing aids are portable hearing devices used to support the hard of hearing. In order to make concessions for the numerous individual requirements, different types of hearing aids are provided, e.g. behind-the-ear (BTE) hearing aids, hearing aids with an external receiver (receiver in the canal [RIC]) and in-the-ear (ITE) hearing aids, for example concha hearing aids or canal hearing aids (ITE, CIC) as well. The hearing aids listed in an exemplary fashion are worn on the concha or in the auditory canal. Furthermore, bone conduction hearing aids, implantable or vibrotactile hearing aids are also commercially available. In this case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually configured as an electroacoustic transducer, e.g. a miniaturized loudspeaker, or as an electromechanical transducer, e.g. a bone conduction receiver. The amplifier is usually integrated into a signal-processing unit. This basic configuration is illustrated in FIG. 1 using the example of a behind-the-ear hearing aid. One or more microphones 2 for recording the sound from the surroundings are installed in a hearing-aid housing 1 to be worn behind the ear. A signal-processing unit 3, likewise integrated into the hearing-aid housing 1, processes the microphone signals and amplifies them. The output signal of the signal-processing unit 3 is transferred to a loudspeaker or receiver 4, which emits an acoustic signal. If necessary, the sound is transferred to the eardrum of the equipment wearer using a sound tube, which is fixed in the auditory canal with an ear mold. A battery 5, likewise integrated into the hearing-aid housing 1, supplies the hearing aid and, in particular, the signal-processing unit 3 with energy.

Children and babies who are hard of hearing can be equipped with hearing aids. However, these instruments should be childproof. BTE hearing aids usually have an ear hook attached to the hearing-aid housing, the former serving to hold the hearing aid against the concha.

However, since it should now be possible to remove the ear hook from the hearing aid or the hearing-aid housing for cleaning purposes, there is a problem in that the child or baby may remove the ear hook from the hearing aid and may possibly swallow it.

At present, most ear hooks are affixed to the respective hearing aid using screw threads. However, in this case a child may also unscrew the ear hook from the hearing aid, which in turn leads to the safety issues outlined above.

In order to solve this problem, a small amount of adhesive was in many cases previously applied to the ear hook such that a much higher force is necessary to remove the ear hook from the hearing aid. An alternative solution consists of affixing the ear hook to the housing with a fine thread such that, even after e.g. 20 rotations, the ear hook is still seated so securely and fixedly on the aid that there are no acoustic problems (feedback).

### SUMMARY OF THE INVENTION

It is accordingly an object of the invention to provide a hearing aid with ear-hook safety mechanism which overcomes the above-mentioned disadvantages of the prior art devices of this general type, in which an ear hook can be affixed in a simple and childproof fashion to the hearing-aid housing.

According to the invention, the object is achieved by a hearing aid to be worn behind an ear, and containing a housing, which houses signal-processing components, and an ear hook, which is embodied for detachable attachment to the housing. The ear hook is moved toward the housing in a first direction during the attachment process, wherein the ear hook and the housing are embodied such that, in order to attach the ear hook to the housing, there is at least one movement of the ear hook in a second direction and a movement of the ear hook in a third direction, which differs from the second direction, wherein both the second and the third direction differ from the first direction. Here, both the second and the third direction can each have a directional component in the first direction.

The different movement directions when attaching the ear hook advantageously ensure that it is not possible to remove the ear hook from the hearing aid by a simple sequence of movements. This significantly improves the child resistance.

Preferably, a first adaptor is affixed to the housing and a second adaptor is affixed to the ear hook, and the two adaptors can be plugged into or onto one another in order to connect the ear hook to the housing. The adaptors can better take account of the mechanical necessities when connecting the ear hook to the housing, for example in respect of the choice of materials.

One of the two adaptors may have at least one guide groove and the other adaptor may have at least one projecting element, and the at least one guide groove may be shaped such that the movements of the ear hook relative to the housing in the second and third direction emerge when the two adaptors are connected. The guide sleeve and the projecting element can easily force the desired movements.

In a further exemplary embodiment, the two adaptors latch into one another in the state where they are completely plugged into or onto one another. This can securely bring the ear hook into a defined final position with respect to the housing.

One of the two adaptors may at least partly consist of a metal. As a result, the respective adaptor can withstand relatively high forces.

Moreover, a metal can reduce the abrasion with respect to most plastics.

Furthermore, the second adaptor can have a sleeve-shaped configuration and can be completely inserted into a recess in the ear hook. This can provide an adaptor that is easy to build.

Moreover, the first adaptor can have a tube port, through which sound is guided into the ear hook from the housing. The tube port then not only contains the function of guiding sound, but also the function of the adaptor.

According to a further embodiment, the movement of the ear hook in the second direction is a clockwise screwing movement and the movement of the ear hook in the third direction is a counterclockwise screwing movement. The two different screwing movements reduce the possibility of chance disassembly by a child.

In a further exemplary embodiment, in order to attach the ear hook to the housing, the ear hook may be moved in the first direction, followed by a movement in the second direction, then by another movement in the first direction and, following this, a movement in the third direction. Provision may also be made for other movement patterns with other sequences of the movement directions or additional movement directions. The movement pattern can increase the disassembly complexity as desired.

In a preferred embodiment, the second direction has at least one directional component that is directed in the opposite direction to a directional component of the third direction. This means that a movement reversal is required during assembly and disassembly of the ear hook, which generally requires a deliberate action.

Other features which are considered as characteristic for the invention are set forth in the appended claims.

Although the invention is illustrated and described herein as embodied in a hearing aid with ear-hook safety mechanism, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a hearing aid according to the prior art;

FIG. 2 is a diagrammatic, perspective view of a first embodiment of a hearing aid with a disassembled hearing aid according to the invention;

FIG. 3 is a diagrammatic, perspective view showing an interface between an ear hook and the hearing aid;

FIG. 4 is a diagrammatic, perspective view of an ear-hook-side adaptor;

FIG. 5 is a diagrammatic, perspective view of the adaptor from FIG. 4, inserted into an ear hook;

FIG. 6 is a diagrammatic, perspective view of the ear hook and a housing-side adaptor as per a second embodiment according to the invention;

FIG. 7 is a diagrammatic, perspective view of the ear hook from FIG. 6 in a different perspective;

FIG. 8 is a diagrammatic, perspective view of the housing-side adaptor from FIG. 6 in an enlarged illustration;

FIG. 9 is a diagrammatic, perspective view of the ear hook and the housing-side adaptor from FIG. 6 in the assembled state; and

FIG. 10 is a diagrammatic, enlarged side view of the housing-side adaptor from FIG. 8.

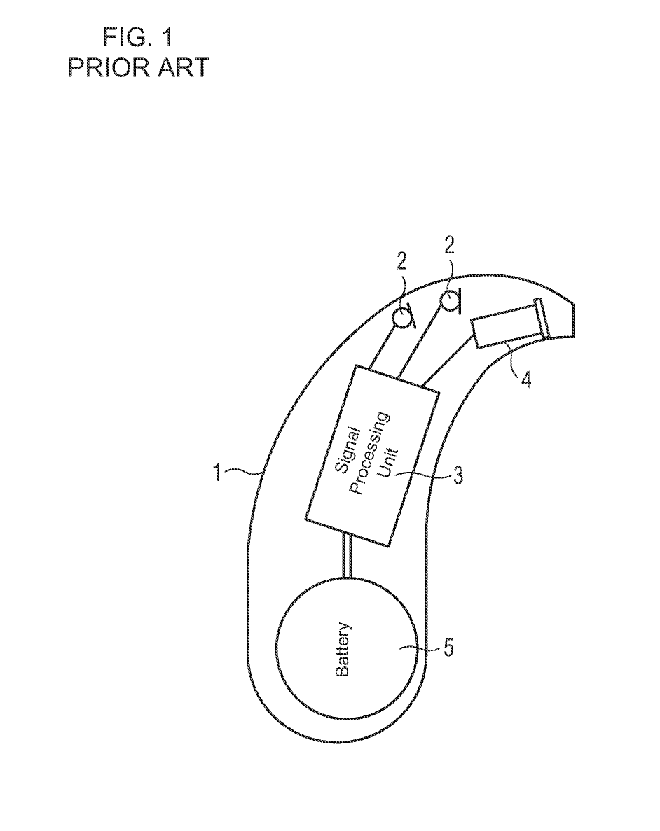

### DETAILED DESCRIPTION OF THE INVENTION

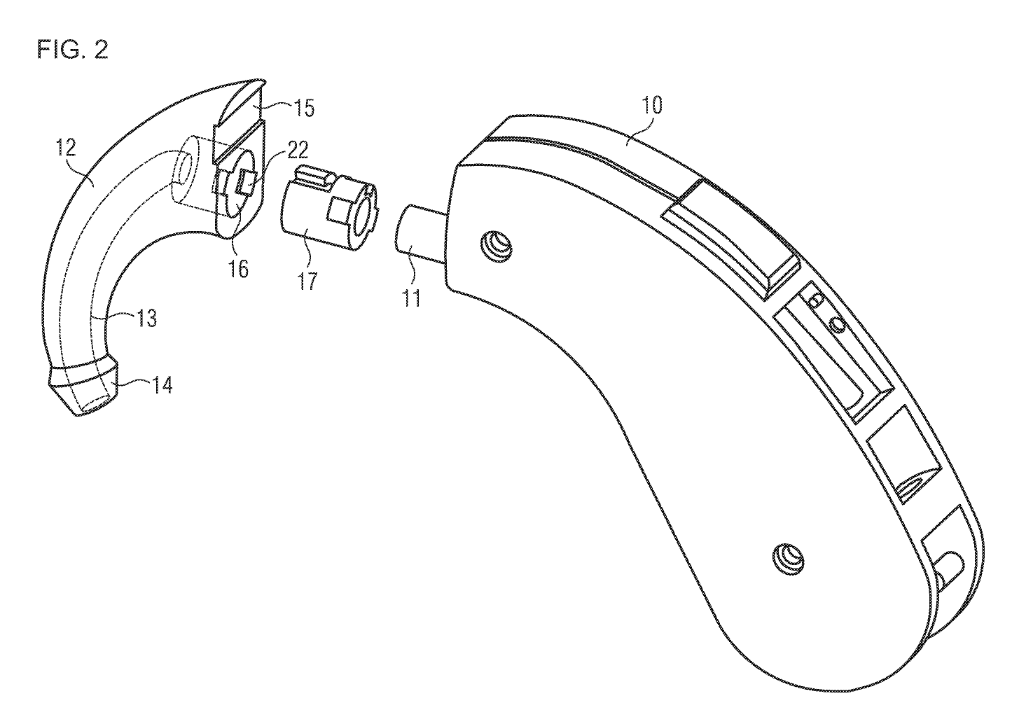

The BTE hearing aid illustrated in FIG. 2 in an exemplary fashion contains a housing 10, in which conventional signal-processing components of the hearing aid are housed. A tube port or a sound-outlet port 11, which protrudes out of the housing 10, guides the output sound from the hearing aid out of the latter. The sound-outlet port 11 is tubular and is part of a housing-side adaptor that is similar to the one in FIG. 8. This first, housing-side adaptor generally has a very stable configuration since it serves to affix an ear hook 12. Thus, it is produced from e.g. metal or ceramics, or at least has a metal core.

FIG. 2 also shows that the ear hook 12 contains a sound channel 13 that runs from the end of the ear hook 12 facing the housing 10 to the end thereof facing away from the housing. At the end facing away from the housing 10, the ear hook 12 has a circumferential thickened portion 14, which serves to fix a sound tube (not illustrated). There is a cylindrical recess 16 on a side 15 of the ear hook facing the hearing-aid housing 10 and the sound channel 13 runs therein at the end face. The recess 16 serves to hold an ear-hook-side (second) adaptor 17. The adaptor 17 has a sleeve-shaped configuration and entirely fits into the recess 16 of the ear hook 12.

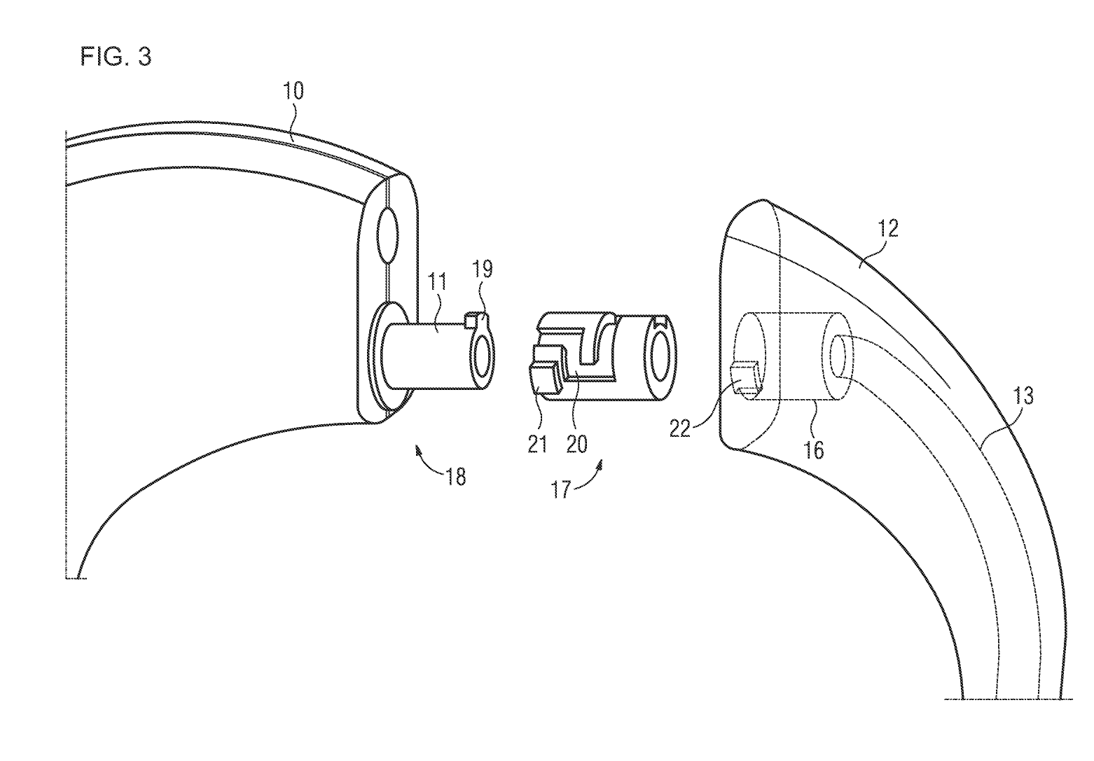

FIG. 3 illustrates another perspective of the mechanical interface between the housing 10 and the ear hook 12 in an enlarged fashion. The housing-side adaptor 18 (first adaptor) contains a radially protruding lug 19 at its free end. It constitutes a projecting element, which guides the movement for affixing the ear hook 12 to the housing 10.

The ear-hook-side adaptor 17 has a guide 20 in which the lug 19 can be moved when the tube port 11 is pushed through the sleeve-shaped adaptor 17. As mentioned previously, the ear-hook-side or the second adaptor 17 is in turn inserted into the recess 16 of the ear hook 12. To this end, it can, for example, be snapped into the recess 16, or attached therein in any other fashion (e.g. by adhesive bonding). So that it sits, secured against twisting, in the recess 16, it has one or more projections 21, which radially protrude from the outer shell of the sleeve-shaped adaptor. Accordingly, the recess 16 in the ear hook 12 also has corresponding notches 22, and so there is anti-twist protection for the adaptor 17 in its inserted state.

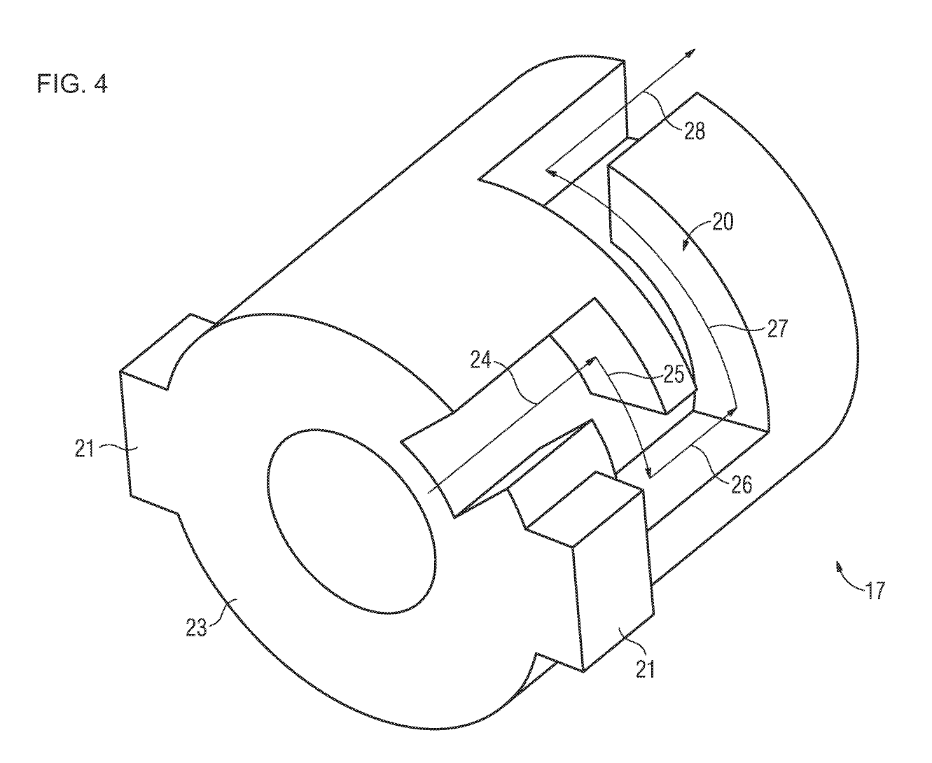

FIG. 4 shows the adaptor in an enlarged illustration. It has a hollow-cylindrical base body 23 with a guide 20. The guide 20 has a first section, which runs in the axial direction (first direction). This first direction is labeled by an arrow 24. This is adjoined by a second section of the guide 20, which runs in the circumferential direction. In order to continue following the second section, starting from the first section, a movement in a clockwise second direction as per arrow 25 is necessary. A third section adjoins the second section of the guide 20; it once again runs in the axial direction (first direction). Should the lug 19 continue to be guided through the guide, it accordingly needs to carry out a movement as per arrow 26. The guide now continues with a fourth section, which runs in the circumferential direction. This section accordingly prescribes a movement direction as per arrow 27. Hence the lug 19 of the tube port 11 should be moved counterclockwise and hence also counter the movement direction 25 in the second section of the guide. A fifth section adjoins the fourth section at the end of the guide, and this fifth section once again runs in the axial direction. Hence, this results in an axial movement as per arrow 28 for the lug 19 of the tube port 11.

Thus, in order to assemble the hearing-aid housing 10 and the ear hook 12, the latter must carry out movements as per arrows 24 to 28. However, this supposes that an additional mechanism such as e.g. a magnet or a snap-fit element holds the ear hook 12 in its final position against the housing 10. An alternative embodiment would consist of only movements as per arrows 24 to 27 being carried out and there being fixing in the circumferential direction at the end, for example by a latching element.

Thus, mounting the ear hook 12 on the housing 10 requires a movement that needs opposing movements in two different sections. This is clarified in FIG. 4 by the arrows 25 and 27, which are directed in opposite directions despite both running in the circumferential direction. Hence the guide 20 leads to a very complex sequence of movements when assembling the ear hook.

The ear hook 12 should be disassembled from the housing 10 in the reverse sequence. Thus, the movement denoted by the arrows 24 to 28 in FIG. 4 should be carried out in reverse. The movement pattern is equally complex, and so the probability of a child inadvertently releasing the ear hook from the housing is reduced.

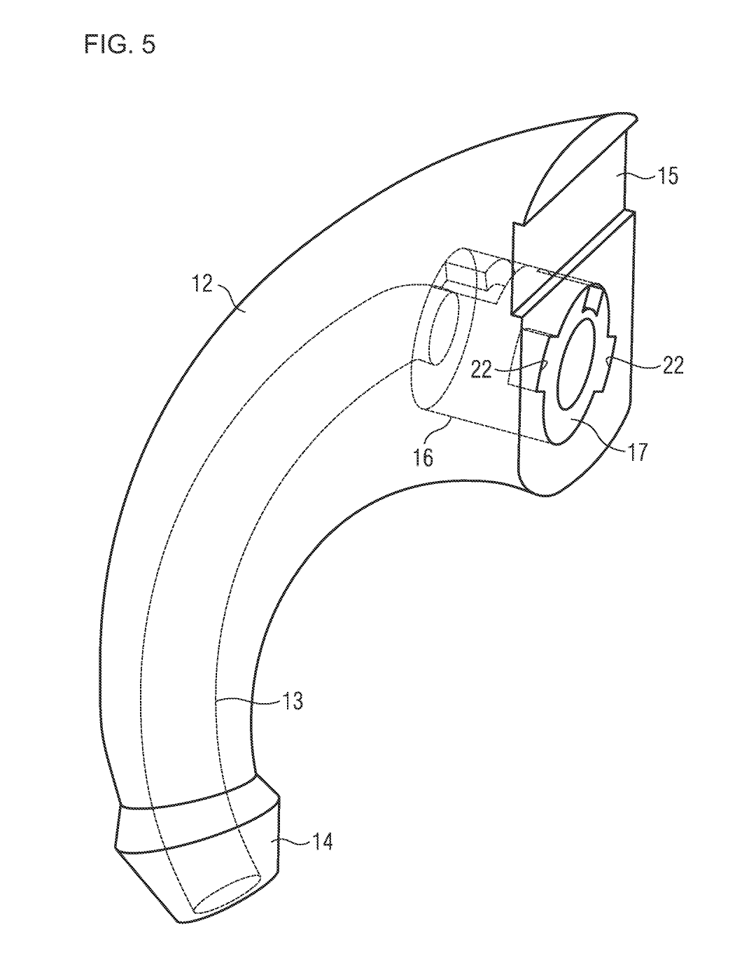

As already mentioned in conjunction with FIG. 3, the second adaptor 17 has two projections, which protrude radially outward and serve as anti-twist protection. FIG. 5 illustrates the state in which the second adaptor 17 is inserted into the recess 16 in the ear hook 12. The projections 21 engage in corresponding notches or recesses 22 (see FIG. 2 as well).

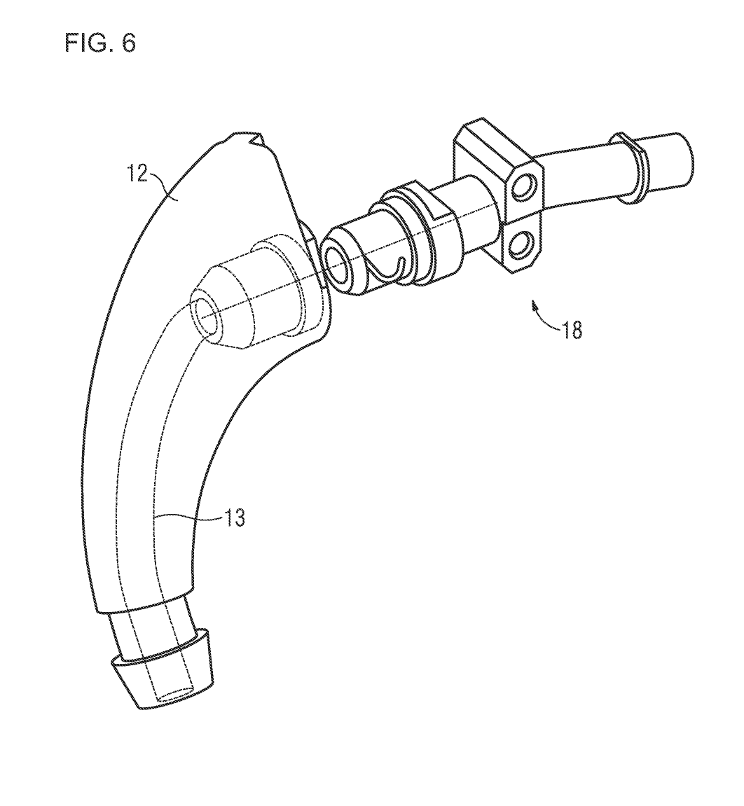

A further exemplary embodiment will now be explained on the basis of FIGS. 6 to 10. Here the ear hook 12, in which the sound channel 13 runs, is also plugged onto the first adaptor 18. The hearing-aid housing is not illustrated in FIG. 6, but the first adaptor 18 is installed in the hearing-aid housing in the final assembled state (see FIGS. 2 and 3). In the present example, it is merely the tip of the adaptor 18 that differs from the adaptor in FIG. 3.

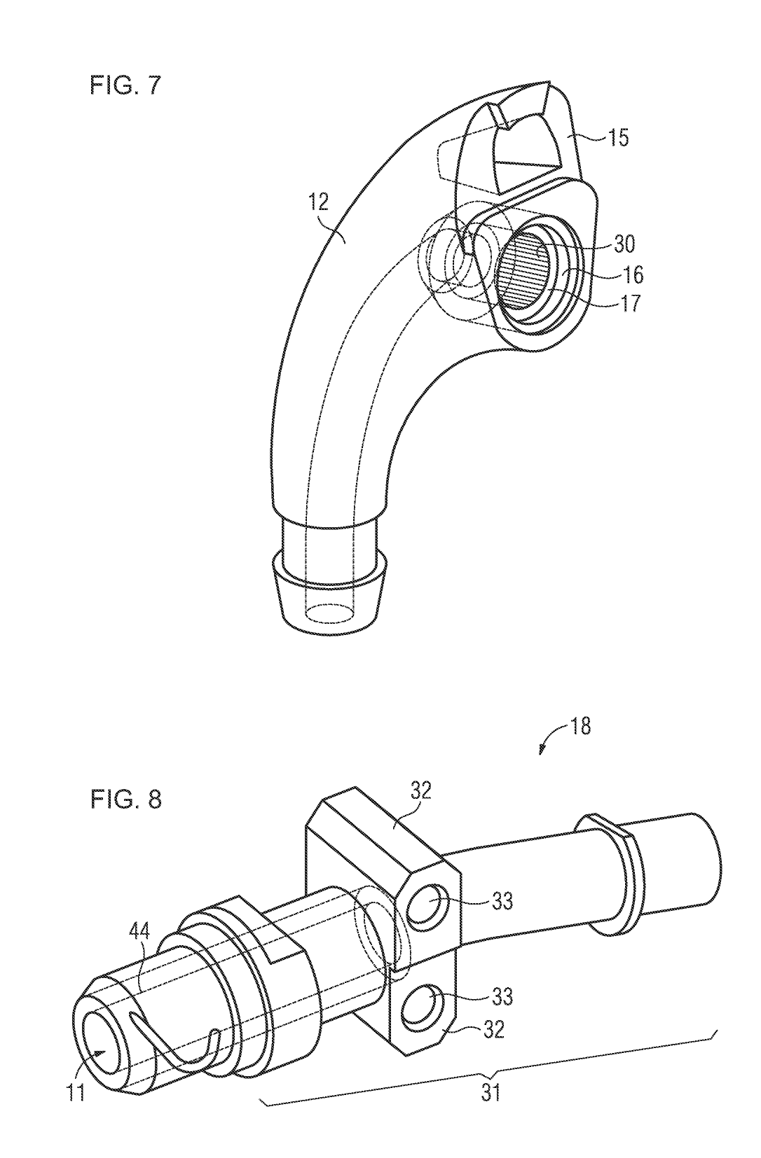

FIG. 7 shows the ear hook 12 from FIG. 6 in that perspective from which it is possible to view the side 15 of the ear hook 12 that faces the hearing-aid housing. The ear hook 12 is made of a plastic. Like in the example of FIG. 2, it has a recess 16 on its side 15. A metal sleeve 17 is inserted into the recess 16. The sleeve 17 in this case also constitutes the second adaptor, into which the first adaptor 18 is plugged. The sleeve 17 has two hemispherical projections 30 as guide element. They project into the interior of the sleeve 17.

A corresponding housing-side adaptor 18 is illustrated in FIG. 8. It has a tube port 11, which projects out of the housing, and a rear section 31 that runs in the hearing-aid housing. It substantially consists of a sound tube that ends at the tube port 11. Attachment elements 32 with bores 33 are provided approximately in the middle of the adaptor in order to anchor the adaptor 18 fixedly in the housing.

Depending on the requirements, the adaptor may be produced from different materials. On the one hand, it may be produced from plastics, metal or ceramics. However, it may moreover also contain a metal tube that is encased in plastic.

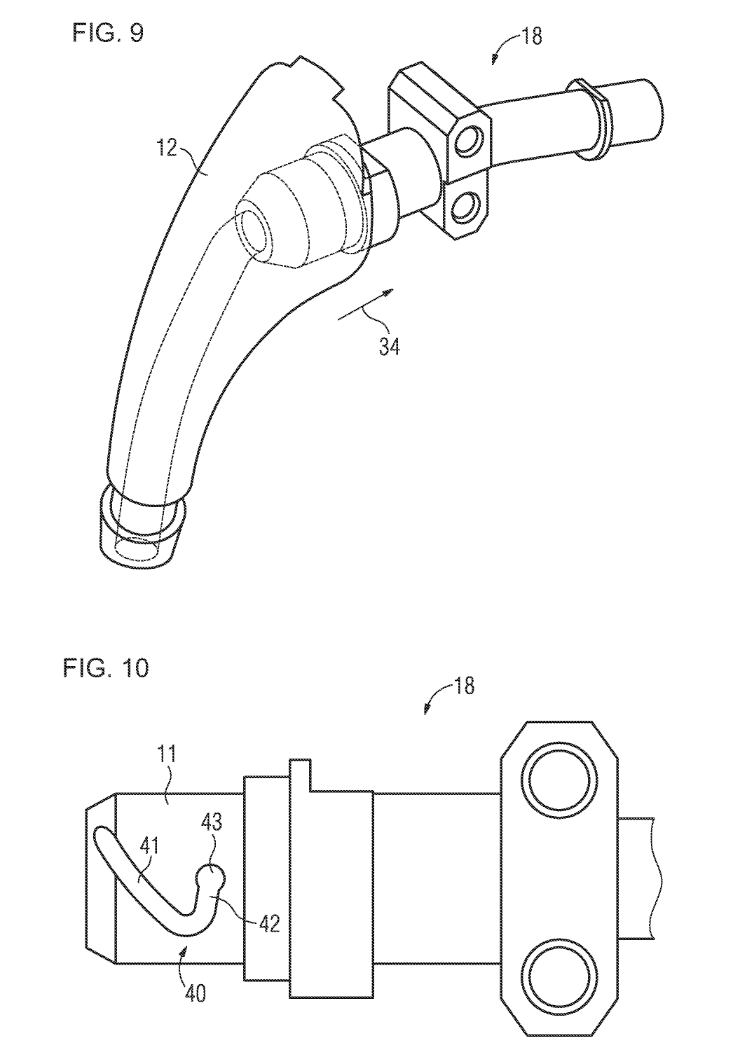

FIG. 9 shows the assembly of ear hook 12 and adaptor 18. Accordingly, the ear hook 12 is plugged onto the tube port 11 of the adaptor 18 in the axial direction thereof as per arrow 24. However, in order to be plugged on, the ear hook 12 must follow a predetermined movement pattern compared to the adaptor 18, as is likewise the case in the preceding exemplary embodiment. In the present case, the tube port 11 of the adaptor 18 as per FIG. 10 contains a guide 40, which is embodied as a groove in the shell surface of the tube port 11. The guide 40 serves for guiding the hemispherical projection 30 of the second adaptor 17 in a predefined fashion. Accordingly, in this case it is first of all necessary, for plugging on purposes, for the ear hook to carry out a clockwise screwing movement. A first section 41 of the guide ensures this. As long as the hemispherical projection 30 is guided in this first section 41, the ear hook 12 undergoes a screw-shaped movement, which contains a component in the axial direction and a counterclockwise component in the circumferential direction.

A second section 42 adjoins the first section 41 of the guide 40; the second section 42 requires a counterclockwise screwing movement of the adaptor 12. Thus, this second movement has a directional component in the axial direction and a counterclockwise directional component in the circumferential direction.

The first section 41 of the guide 40 is connected to the second section by a curve. Moreover, there is an enlargement of the groove, or there is a depression 43 thereof, at the end of the second section, into which the hemispherical projection 30 of the first adaptor 17 can penetrate more deeply. This results in a latching position, which corresponds to the final assembled position of the ear hook 12 on the adaptor 18 or the housing 10.

Hence, a complex movement during the assembly of the ear hook 12 is also required in this case, which requires a movement with a certain directional component in one section, and a movement with an opposing directional component in a second movement section.

The ear hook 12 is disassembled from the adaptor 18 against the arrow 34 in FIG. 9. To this end, the snap-fit connection must first of all be released in a first step with increased force and the hemispherical projection 30 must be rotated out of the depression 43. The hemispherical projection 30 must subsequently be pushed out of the guide 40, first of all along the second section 42 of the guide and subsequently along the first section 41 thereof. To this end, after the latching or snap-fit connection has been released, the ear hook 12 must, during its axial movement counter to the arrow 34, firstly undergo a clockwise rotational movement and subsequently undergo a counterclockwise rotational movement. Overall, this results in the opposing movement pattern than during the assembly of the ear hook 12 onto the adaptor 18.

In order to ensure a secure guide corresponding to the desired movement pattern, a plurality of guides 40 can be arranged distributed over the circumference of the first adaptor 18. A corresponding number of projections should then be provided on the second adaptor 17. By way of example, two guides 40 are advantageously arranged at opposite locations on the tube port 11.

By way of example, the tube port 11 may be produced by insert molding using an injection molding process, wherein a metal tube, which forms the sound tube, is inserted into the mold while a shell with the guide 40 is injected around the tube. The inner metal tube 44 is indicated in FIG. 8. It ensures acoustic and mechanical stability. As a result of injection molding, complicated guides can be impressed into the adaptor with little effort. As a result, it is not that easy for children to remove the ear hook from the hearing aid, because knowledge relating to the system mechanism or the required movement pattern is required.

1. A hearing aid to be worn behind an ear, the hearing aid comprising:
signal-processing components;
a housing said signal-processing components; and
an ear hook embodied for detachable attachment to said housing, said ear hook being moved toward said housing in a first direction during an attachment process, said ear hook and said housing embodied such that, in order to attach said ear hook to said housing, there is at least one movement of said ear hook in a second direction and a movement of said ear hook in a third direction, which differs from said second direction, and both the second and the third direction differ from the first direction.

2. The hearing aid according to claim 1, further comprising:
a first adaptor affixed to said housing; and
a second adaptor affixed to said ear hook, said first and second adaptors can be plugged into or onto one another to connect said ear hook to said housing.

3. The hearing aid according to claim 2, wherein one of said first and second adaptors has at least one guide groove formed therein and the other of said first and second adaptors has at least one projecting element, said at least one guide groove is shaped such that movements of said ear hook relative to said housing in the second and third directions emerge when said first and second adaptors are connected.

4. The hearing aid according to claim 2, wherein said first and second adaptors latch into one another in a state where they are completely plugged into or onto one another.

5. The hearing aid according to claim 2, wherein one of said first and second adaptors is at least partly formed from metal.

6. The hearing aid according to claim 2, wherein:
said ear hook has a recess formed therein; and
said second adaptor has a sleeve-shaped configuration and is completely inserted into said recess in said ear hook.

7. The hearing aid according to claim 2, wherein said first adaptor has a tube port through which sound is guided into said ear hook from said housing.

8. The hearing aid according to claim 1, wherein the movement of said ear hook in the second direction is a clockwise screwing movement and the movement of said ear hook in the third direction is a counterclockwise screwing movement.

9. The hearing aid according to claim 1, wherein, in order to attach said ear hook to said housing, said ear hook is moved in the first direction, followed by the movement in the second direction, then by another movement in the first direction and, following this, the movement in the third direction.

10. The hearing aid according to claim 1, wherein the second direction has at least one directional component that is directed in an opposite direction to a directional component of the third direction.
